(19) United States
(12) Patent Application Publication
(10) Pub. No.: US 2005/0206612 A1
(43) Pub. Date: Sep. 22, 2005

(54) Image control accelerometer system and method

(76) Inventor: Kong Leong Teng, Jalan Chee Seng (MY)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/803,339

(22) Filed: Mar. 17, 2004

(51) Int. Cl. G09G 5/00

(52) U.S. Cl. 345/156

(57) ABSTRACT

An image control accelerometer system and method are disclosed. For example, an image control accelerometer system can include an accelerometer module, a movement analysis module, and an input protocol generation module. The accelerometer module is communicatively coupled to the movement analysis module which is communicatively coupled to the input protocol generation module. The accelerometer module detects movement of the image control accelerometer system. The movement analysis module then determines a direction of the movement. Once the movement direction is determined, the input protocol generation module generates a signal that indicates the direction of the movement.

### FIELD

The present invention relates to an information input system and method. More particularly, in one exemplary implementation the present invention relates to an image control accelerometer system and method.

### BACKGROUND

Electronic systems and circuits are utilized in a number of applications to achieve advantageous results. Frequently, these advantageous results are realized through interaction with users. For example, conventional computer systems typically include several mechanisms for enabling a user to interact with the computer system. Computer systems often have a display for displaying images such as a cursor and a cursor control device such as computer mouse that is communicatively coupled to the computer system. A user can interact with the computer system by moving the mouse and observing corresponding movements of an image (e.g., a cursor, icon, etc.) displayed on the display screen.

Traditional computer mice typically require interaction with a surface to operate and are usually susceptible to number of conditions that can adversely impact interactions with the surface. For example, there are traditional ball mechanical computer mice. A ball computer mouse usually has a ball that is dragged across a surface and as the ball rotates corresponding movements are made in the cursor location on the display. However, there are a number of things that can impact the performance of a traditional ball mouse. For example, the movement of the ball can be impacted by dust, dirt and/or grime that clogs the mechanisms. In addition, the surface the ball is dragged across can be rough resulting in jumpy and/or inaccurate movement of the cursor. A similar affect can occur if the surface of the ball is damaged.

Another type of traditional computer mouse is an optical computer mouse. An optical computer mouse usually senses movement based upon reflections of light from a surface. Again the surface upon which the optical mouse relies to reflect the light can have a significant impact on performance. An optical mouse usually has difficulty operating correctly if the surface is very shiny or reflective such as glass, etc. and can result inaccurate movement of the cursor or image.

An image control accelerometer system and method are disclosed. For example, an image control accelerometer system can include an accelerometer module, a movement analysis module, and an input protocol generation module. The accelerometer module is communicatively coupled to the movement analysis module which is communicatively coupled to the input protocol generation module. The accelerometer module detects movement of the image control accelerometer system. The movement analysis module then determines a direction of the movement. Once the movement direction is determined, the input protocol generation module generates a signal that indicates the direction of the movement.

### BRIEF DESCRIPTION OF THE DRAWINGS

FIG. 1 is a block diagram of an information input system in accordance with one embodiment of the present invention.

FIG. 2 is a block diagram of an information input system in accordance with another embodiment of the present invention.

FIG. 3 is a block diagram of an information input system in accordance with yet another embodiment of a present invention.

FIG. 4 is a block diagram of an accelerometer structure in accordance with one embodiment of the present invention.

FIG. 5 is a block diagram accelerometer structures orientation in accordance with one embodiment of the present invention.

FIG. 6 is a flow chart of information input detection method in accordance with one embodiment of the present invention.

### DETAILED DESCRIPTION

Image control accelerometer systems and methods in accordance with the present invention facilitate efficient and convenient image control and information input activities. In one exemplary implementation, the present invention relates to inputting information to a computer system with a microstructure accelerometer cursor control system and method. For example, a microstructure accelerometer computer mouse in accordance with embodiments of the present invention can be utilized to control a variety of images (e.g., a cursor, icon, game piece, etc.) on a computer system display. The images can be controlled and/or information can be input with minimal or no impacts associated traditional mechanical or optical mouse problems (e.g., dirt clogged mouse mechanisms and/or inaccurate movement of the cursor resulting from rough and/or shiny surfaces). A present invention information input system can operate suspended in air and an image can be controlled without running the mouse across a surface.

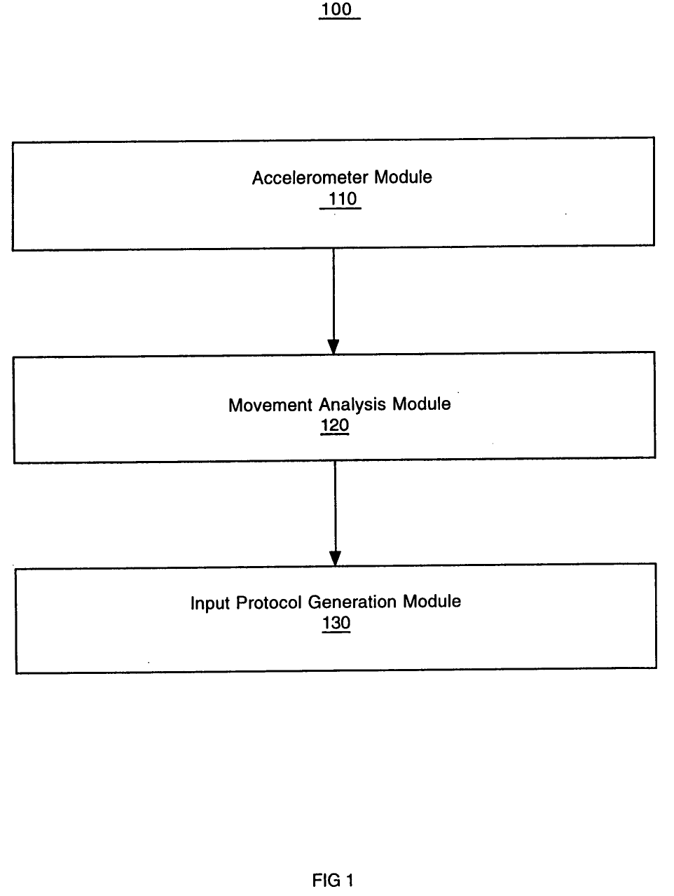

FIG. 1 is a block diagram of image control accelerometer system 100 in accordance with one embodiment of the present invention. In one embodiment, information input system 100 is utilized as a computer image control device (e.g., a computer mouse). For example, image control accelerometer system 100 detects movements in a computer mouse and forwards corresponding movement direction indications to a computer system. For example, the movement direction indications can be utilized to control image movements (e.g., movement of cursor, icon, game piece, etc.) on a display of a computer system.

Image control accelerometer system 100 includes an accelerometer module 110, movement analysis module 120, and input protocol generation module 130. Movement analysis module 120 is communicatively coupled to accelerometer module 110 which is communicatively coupled to input protocol generation module 130. The components of image control accelerometer system 100 cooperatively operate to provide information on the movement of an information input device (e.g., computer mouse, joystick, etc.). Accelerometer module 110 detects movement of image control accelerometer system 100. For example, accelerometer module 110 detects movement of image control accelerometer system 100 associated with controlling an image on a display screen. Movement analysis module 120 determines a direction of the movement. For example, movement analysis module 120 can determine if a movement corresponds to up or down, left or right, or if the accelerometer system 100 is stationary. Input protocol generation module 130 generates input indication signals that indicate the direction of the movement. For example, the input indication signals can be forwarded to a computer system for coordinating movement of images on a display.

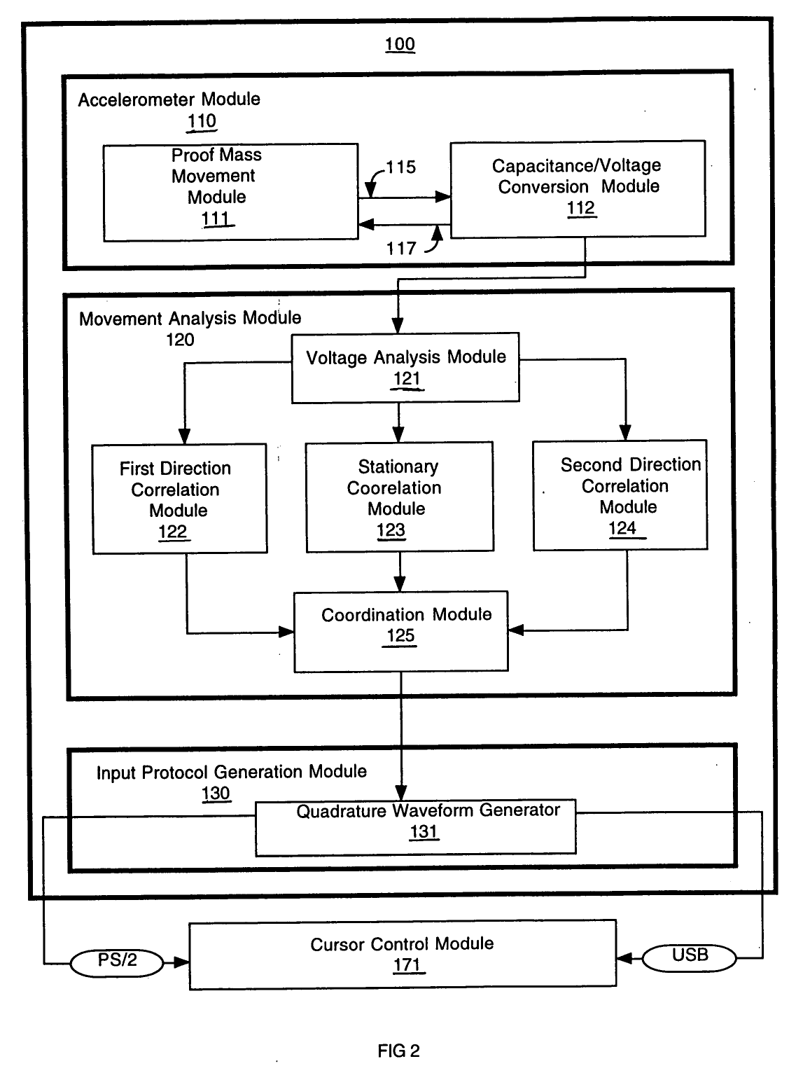

FIG. 2 is a block diagram of image control accelerometer system 100 in accordance with one embodiment of the present invention. Accelerometer module 110 includes proof mass module 111 and capacitance/voltage conversion module 112. Proof mass module 111 is communicatively coupled to capacitance/voltage conversion module 112. Proof mass module 111 changes capacitance characteristics of a capacitance component based upon movement of a proof mass. Capacitance/voltage conversion module 112 converts changes in a capacitance to changes in a voltage. In one embodiment, an input voltage 115 is supplied to a changing capacitance of proof mass module 111 and a resulting output voltage 117 is returned to capacitance/voltage conversion module 112.

In one embodiment, movement analysis module 120 includes voltage analysis module 121, first direction correlation module 122, stationary module 123, second direction correlation module 124, and coordination module 125. Voltage analysis module 121 is communicatively coupled to first direction correlation module 122, stationary correlation module 123, and second direction correlation module 124, which are in turn communicatively coupled to coordination module 125.

Voltage analysis module 121 analyzes a change in a voltage level. In one exemplary implementation, voltage analysis module 121 determines if a voltage level is greater than a threshold value (e.g., 2.5 volts), the same as a threshold value, or less than a threshold value. Alternatively, voltage analysis module 121 can determine if the relative change in a voltage level is greater than a threshold value. For example, voltage analysis module 121 can determine a voltage level change from 3 volts to 7 volts is greater than a threshold value of 2.5 volts. In one exemplary implementation, voltage analysis module 121 provides first direction correlation module 122, stationary correlation module 122, and second direction correlation module 123 with the results of the analysis.

First direction correlation module 122 correlates a change in voltage greater than the threshold value to a first direction. In one embodiment, the first direction can be associated with a movement to the “left’ or alternatively the first direction can be associated with a movement “down”. For example, if the voltage is greater than a threshold value (e.g., 2.5 volts) the direction is determined to be “left” or alternatively “down”. In one exemplary implementation, first direction correlation module correlates a relative change of more than a threshold value to the first direction. For example, if the relative voltage change is greater than a threshold value the direction is determined to be “left” or alternatively “down”.

A second direction correlation module 124 correlates a change in voltage less than a threshold value to a second direction. In one embodiment, the second direction can be associated with a movement to the “right” or alternatively the second direction can be associated with a movement “up”. For example, if the voltage is greater than a threshold value (e.g., 2.5 volts) the direction is determined to be “right” or alternatively “up”. In one exemplary implementation, second direction correlation module correlates a relative voltage change of more than a threshold value to the second direction. For example, if the voltage change is less than a threshold value the direction is determined to be “right” or alternatively “up”.

Stationary correlation module 123 correlates a voltage at a predetermined threshold value to a stationary status. For example, if the voltage is at a threshold value (e.g., 2.5 volts) the mouse is stationary. In one exemplary implementation, limited relative voltage level change can be correlated to a stationary status. For example, when a relative voltage level change remains within a first threshold value (e.g., +2.5 volts) and a second threshold value (e.g., −2.5 volts) a mouse is considered stationary.

It is appreciated that the present invention can be implemented with a variety of movement and voltage correlation schemes. In one exemplary implementation, different threshold values can be correlated to different directions. For example, voltage levels greater than a first threshold value of positive 2.5 volts can be associated with a first direction and voltage levels less then a negative 2.5 volts can be associated with a second direction. Voltage levels between the first threshold value of positive 2.5 volts and the second threshold value of negative 2.5 volts are correlated to a stationary status.

Coordination module 125 coordinates direction indications and forwards the information to input protocol module generation module 130. For example, coordination module 125 coordinates if the direction is up or down and left or right.

In one embodiment, input protocol generation module 130 includes quadrature waveform generator module 131 for generating quadrature waveform signals. Phases shifts in different channel square waves of the quadrature waveform signals correspond to the movement direction. For example, input protocol generation module 130 can generate signals in which a first channel signal leading a second channel signal corresponds to a movement to the left and a second channel signal leading a first channel signal corresponds to a movement to the right.

In one embodiment, the input protocol generation module 130 output is forwarded to a cursor control module 171. In one exemplary implementation, cursor control module 171 is included in a personal computer. Input protocol generation module 130 can forward the signals in a universal serial buss (USB) compatible format and/or a PS2 compatible format.

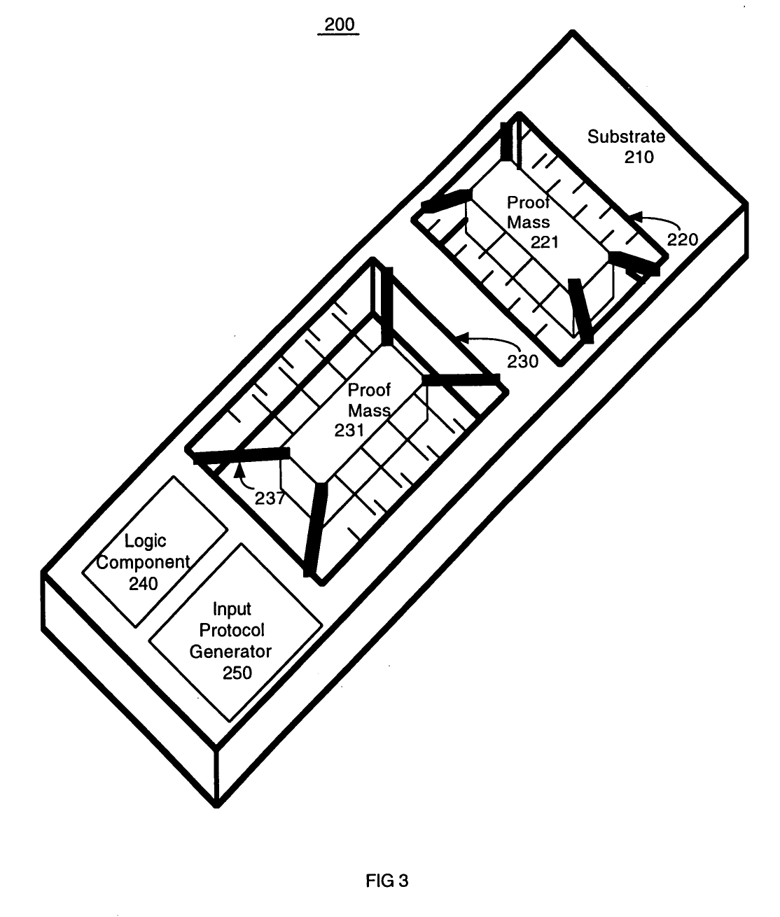

FIG. 3 is a block diagram of image control accelerometer system 200 in accordance with one embodiment of a present invention. Image control accelerometer system 200 includes substrate 210, accelerometer structures 220 and 230, logic component 240 and input protocol generation module 250. Accelerometer structures 220 and 230, logic component 240 and input protocol generation module 250 are mounted in substrate 210. Logic component 240 is communicatively coupled to accelerometer structure 220 and input protocol generation module 250. Accelerometer structures 220 and 230 include a proof of mass 221 and 231 respectively and accelerometer structures 220 and 230 are suspended by support structures (shown typically as 237).

The components of accelerometer structure 230 cooperatively operate to detect movement direction of image control accelerometer system 200. Accelerometer structures 220 and 230 detect movement (e.g. associated with controlling an image on a display screen). Logic circuit 240 determines a direction associated with the movement. Input protocol generation component 250 generates an information input signal. In one embodiment, logic circuit 240 determines the movement direction of proof masses 221 and 231 in accelerometer structures 220 and 230 and forwards an indication of the direction to input protocol generation component 250. In one exemplary implementation logic circuit 240 is an application specific integrated circuit (ASIC) that directs application of a voltage to the accelerometer structures and directs measurement of changes in said voltage. In one exemplary implementation, input protocol generation component 250 generates an information input signal in an input protocol compatible form that corresponds to the movement direction. For example, an input protocol generation component 250 can generate a quadrature waveform information input signal or alternatively a PS2 information input signal.

In one embodiment, input protocol generation component 250 is a quadrature waveform generator for generating quadrature waveform signals. The quadrature signal waveform includes a first channel square wave and a second channel square wave that are shifted ninety degrees out of phase. A leading and lagging relationship between the first channel square wave and the second channel square wave indicates a movement direction. The quadrature signal waveform can be compatible with a universal serial bus (USB) mouse controller integrated circuit.

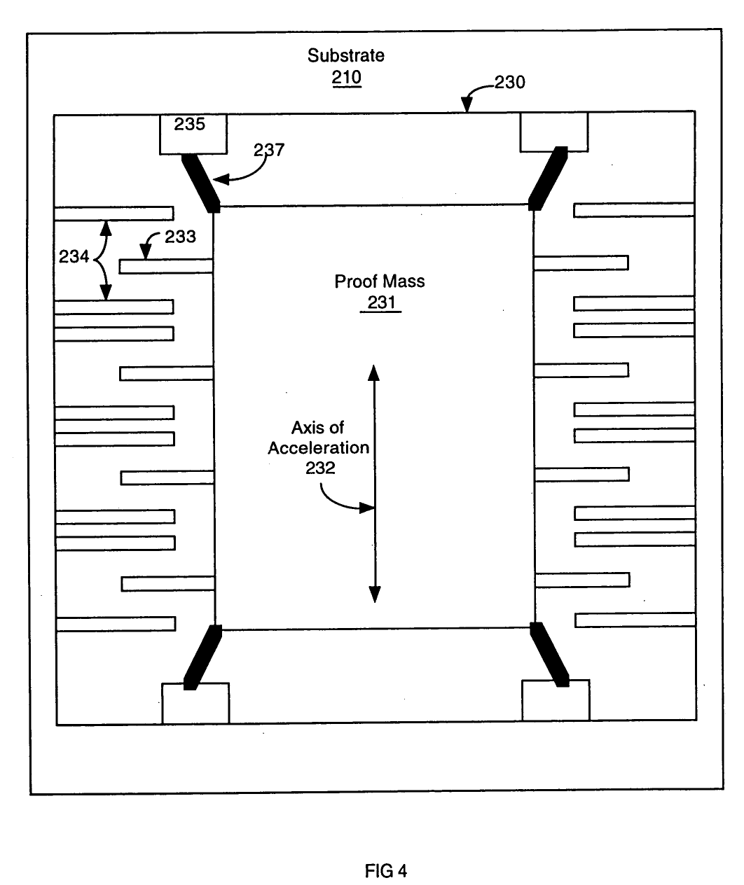

FIG. 4 is a block diagram of accelerometer structure 230 in accordance with one embodiment of the present invention. Accelerometer structure 230 includes proof mass 231, support structures 237, foundation component 235, movable silicon fingers 233 and stationary silicon fingers 234. Proof mass 231 is coupled to support structures 237 which in turn are coupled to foundation components 235. Proof mass 231 is also coupled to movable silicon fingers 233. Stationary silicon fingers 234 are coupled to substrate 210. In one embodiment, accelerometer structure 230 is a micro-electronic mechanical structure (MEMS) fabricated in a semiconductor fabrication process.

Proof mass 231 acts as a mass that moves according to forces applied to a device (e.g., a computer mouse, joystick, etc.) which includes image control accelerometer system 200. In one embodiment, proof mass 231 is made of silicon mass. Support structures 237 suspend proof mass 231 and permit movement depending upon accelerations acting upon the proof mass 231. For example, accelerations acting upon axis of acceleration 232. In one exemplary implementation, support structures 237 are silicon springs. Movable silicon finger components 233 move in conjunction with the proof mass 231. Stationary silicon fingers 234 form a variable capacitance structure with movable silicon fingers 233 in which the capacitance varies in accordance with movement of movable silicon fingers 233 For example, a voltage is applied across moveable silicon fingers 234 and stationary fingers 233.

Movements of the moveable silicon fingers 234 relative to the stationary fingers 233 produce variations in the capacitance which cause a change in the voltage.

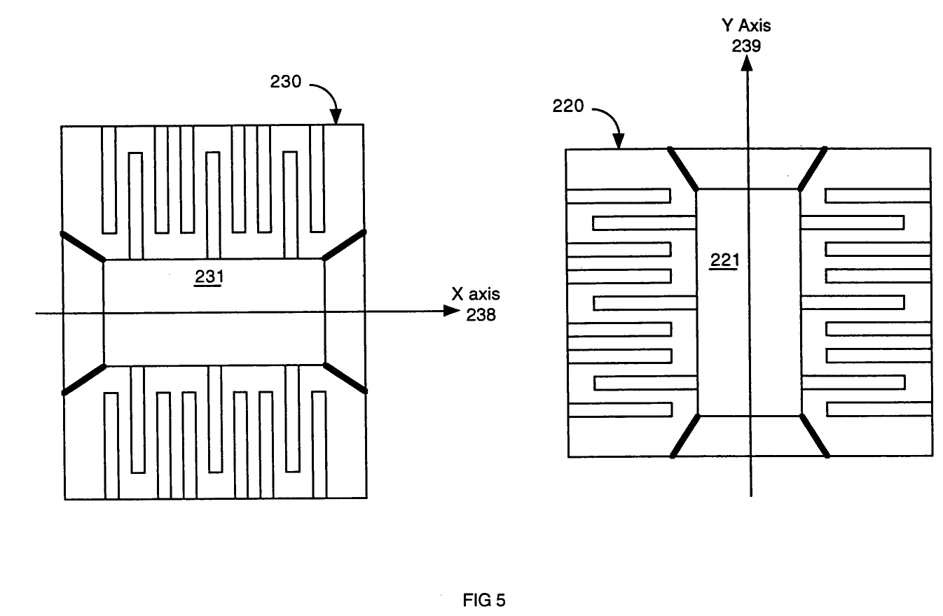

It is appreciated that accelerometer structures 220 and 230 can be configured in a variety of orientations corresponding to different movement directions. FIG. 5 is a block diagram of one exemplary orientation of accelerometer structures 220 and 230 in accordance with one embodiment of the present invention. The proof mass 231 of accelerometer structure 230 is oriented for movement detection in a first and second direction corresponding to X axis 238. For example, the first direction can correspond to movements to the left along X axis 238 and the second direction can correspond to movements to the right along X axis 238. These first and second directions can also correspond to left and right movements on a display screen. The proof mass 221 of accelerometer structure 220 is oriented for movement detection in a first and second direction corresponding to Y axis 239. For example, the first direction can correspond to movements to up the Y axis 239 and the second direction can correspond to movements down the Y axis 239. These first and second directions can also correspond to up and down movements on a display screen.

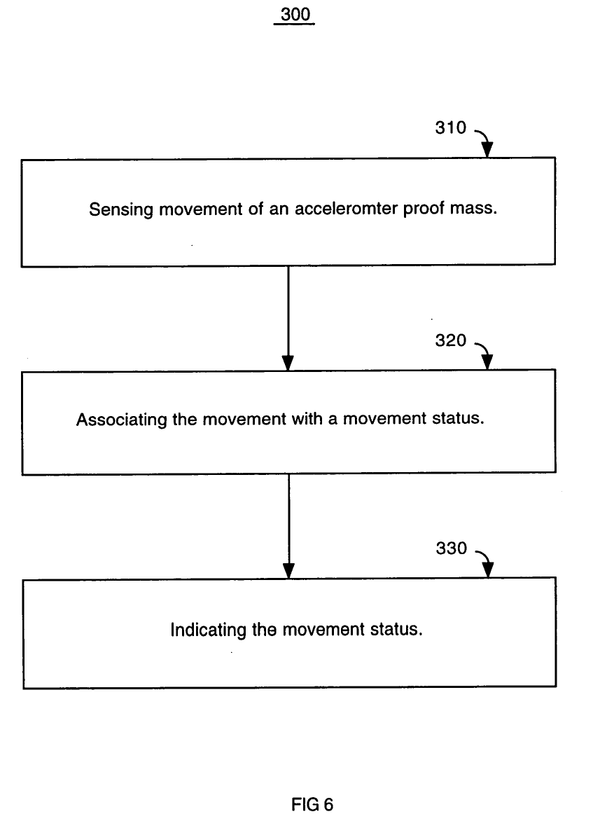

FIG. 6 is a flow chart of image control accelerometer method 300 in accordance with one embodiment of the present invention. In one embodiment, image control accelerometer method 300 is utilized to detect movement of a computer cursor control device (e.g., a computer mouse). For example, image control accelerometer method 300 detects movements in a computer mouse and forwards corresponding cursor control signals to a computer system.

In step 310, movement of an accelerometer proof mass is sensed. In one embodiment the sensing includes changing a capacitance characteristic in response to a movement of the proof mass and altering a voltage to correspond to changes in the capacitance characteristics.

In step 320, the movement is associated with a movement status. In one embodiment of the present invention, a determination is made if the voltage is at, above or below a predetermined value and is associated with a status corresponding to movement in a first direction, a stationary status, or a status corresponding to movement in a second direction. It is appreciated that the present invention can be implemented with a variety of movement and voltage association schemes. For example, movement can be associated with changes in a voltage with respect to a predetermined threshold value and/or relative changes in a voltage. For example, a voltage level and/or changes in a relative voltage level greater than a threshold value can be associated with a first direction movement status and a voltage level and/or changes in a relative voltage level less than a threshold value can be associated with a second direction movement status. Voltage levels between a first threshold value and the second threshold value can be associated with a stationary status.

In step 330, the movement status. In one embodiment, the indication can correspond to a movement status that is stationary, up, down, left or right. In one exemplary implementation the plane of the movement is approximately parallel to a display plane.

The present invention image control accelerometer systems and methods can also provide image movement speed control indications. In one embodiment of the present invention, the relative speeds at which voltage levels across movable silicon fingers and stationary silicon fingers of a present invention accelerometer structure are tracked and forwarded to a computer system. The computer system utilizes the speed indications in determining how fast or slow to move an image (e.g., cursor, icon, game piece, etc.) on a display screen.

Thus, a present invention image control accelerometer system and method facilitate efficient and convenient input of information and image movement control (e.g., cursor control). A microstructure accelerometer in accordance with embodiment of the present invention permit information input and cursor control to be implemented with minimal or no impacts associated traditional mechanical problems (e.g., dirt clogged mouse mechanisms and/or inaccurate movement of the cursor resulting from rough and/or non-reflective surfaces). A present invention image control accelerometer system can operate suspended in air without the need for a surface, facilitating increase mobility in portable devices that would otherwise require the device to be operated in proximity to a surface.

The foregoing descriptions of specific embodiments of the invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. An image control accelerometer system comprising:
an accelerometer module for detecting movement;
a movement analysis module for determining a direction of said movement; and
an input protocol generation module for generating input indication signals that indicate a direction of said movement.

2. The system of claim 1 wherein said accelerometer module detects movements in a computer mouse and said input protocol generation module forwards corresponding cursor control signals to a computer system.

3. The system of claim 1 wherein said accelerometer module comprises:
a proof mass module for changing capacitance characteristics based upon movement of a proof mass; and
a capacitance/voltage conversion module for converting said changing capacitance characteristics to corresponding voltage changes.

4. The system of claim 1 wherein said movement analysis module comprises:
a voltage analysis module for analyzing a change in a voltage level;
a first direction correlation module for correlating a change in said voltage level greater than a threshold value to a first direction;
a stationary correlation module for correlating a voltage level at said threshold value to a stationary status; and
a second direction correlation module for correlating a change in said voltage level less than a threshold value to a second direction.

5. The system of claim 4 further comprising a coordination module for coordinating direction indications from said first direction correlation module, said stationary correlation module, and said second direction correlation module and forwarding direction indication information to said input protocol module generation module.

6. The system of claim 1 wherein said input protocol generation module includes a quadrature waveform generator module for generating quadrature waveform signals.

7. The system of claim 6 wherein phases shifts in different channel square waves of said quadrature waveform signals correspond to said direction of said movement.

8. An image control accelerometer method comprising:
sensing movement of an accelerometer proof mass;
associating said movement with a movement status; and
indicating said movement status.

9. The method of claim 8 wherein said sensing comprises:
changing a capacitance characteristic in response to a movement of said proof mass; and
altering a voltage to correspond to changes in said capacitance characteristic.

10. The method of claim 8 wherein said correlating includes:
determining if a voltage level is at, above or below a threshold value;
associating a first direction movement status with a voltage level greater than said threshold value;
associating a second direction movement status with voltage less than said threshold value; and
associating a stationary movement status with a voltage level at said threshold value.

11. The method of claim 9 wherein said indicating said direction includes indicating if a movement is up or down and left or right.

12. The method of claim 9 wherein a plane of said movement is approximately parallel to a display plane.

13. An image control accelerometer system comprising:
an accelerometer for detecting movement associated with controlling an image on a display screen;
a logic circuit for obtaining a voltage corresponding to said movement, said logic component communicatively coupled to said accelerometer; and
a input protocol generation component for generating an information input signal, said input protocol generation component communicatively coupled to said control circuit.

14. The system of claim 13 wherein said logic component is an application specific integrated circuit that directs application of a voltage to said accelerometer and directs measurement of changes in said voltage.

15. The system of claim 13 wherein said accelerometer comprises:
a silicon mass that moves based upon forces applied to said system;
a silicon spring for suspending said silicon mass and permitting movement depending upon accelerations associated with said forces;
a movable silicon finger component that moves in conjunction with said silicon mass; and
a stationary silicon finger that forms a variable capacitance structure with said movable silicon finger, wherein said capacitance varies in accordance with movement of said movable silicon finger.

16. The system of claim 15 wherein a voltage is applied across said moveable silicon finger and said stationary finger and variations in said capacitance cause changes in said voltage.

17. The system of claim 13 wherein said input protocol generation component is a quadrature waveform generator for generating quadrature waveform signals.

18. The system of claim 17 wherein said quadrature signal waveform includes a first channel square wave and a second channel square wave that are shifted ninety degrees out of phase.

19. The system of claim 18 wherein a leading and lagging relationship between said first channel square wave and said second channel square wave indicates a movement direction.

20. The system of claim 17 wherein said quadrature signal waveform is compatible with a universal serial bus (USB) mouse controller integrated circuit.
